(19) United States
(12) Patent Application Publication
(10) Pub. No.: US 2003/0224833 A1
(43) Pub. Date: Dec. 4, 2003

(54) Cellular base station power generator having remote monitoring and control

(76) Inventors: Thomas Egan, Kildare (IE); Giorgio Bettale, Via Don Minzoni (IT); Carlo Rosastri, Via Don Minzoni (IT); Ioleo Beltrami, Via Don Minzoni (IT); Nick McGrath, Kildare (IE); James Nolan, Kildare (IE); Paul Doyle, Kildare (IE)

Correspondence Address: NIXON & VANDERHYE P.C./G.E., 1100 N. GLEBE RD., SUITE 800, ARLINGTON, VA, 22201, US

(21) Appl. No.: 10/156,643

(22) Filed: May 29, 2002

(51) Int. Cl. H04M 1/00; H04B 1/38

(52) U.S. Cl. 455/572

(57) ABSTRACT

An electrical power generator for outputting on-site electrical power comprises an engine; an alternator operatively coupled to the engine; a controller, operatively coupled to the engine and alternator for controlling at least one operational parameter relating to the engine or alternator, and a modem operatively coupled to the controller for receiving data from a remote source, the received data then being processed by the controller to control the operation parameter.

### BACKGROUND OF THE INVENTION

This invention relates to electric power generators and particularly to an electric power generator which is monitored and controlled by a remote processing system and which provides electrical power to a cellular phone base station.

In recent years, consumer demand for effective cellular phone service has risen dramatically. Consumers now often demand cellular phone service wherever they and their respective cellular phones happen to be located. Specifically, customers now often demand “coast-to-coast” cellular service. In order to satisfy this demand, cellular base stations must be placed and operated in various locations so that effective wireless communication (transmission and reception) can be established between a particular cellular base station and any cellular phone(s) located in the same geographic cellular area served by that particular cellular base station.

Some of the locations (e.g., remote rural areas) at which cellular base stations are placed will typically not have access to mains power infrastructure to supply the primary electrical power required to operate a cellular base station. In order to provide effective cellular service in these remote geographic areas, it may therefore be beneficial to provide the electrical power required by a cellular base station with an on-site electrical power generator. Moreover, even if a cellular base station receives primary electric power from the mains power infrastructure, there often remains a need for a back-up power supply in case the mains power fails.

If an on-site power generator is used to provide electrical power to a cellular base station located in a remote area, it would be further beneficial to maximize the amount of time between maintenance services and to have the capability to remotely monitor and control the on-site generator (i.e., monitor and control the on-site generator from a location which is remote from the onsite generator). This remote monitoring and control would help, for example, to minimize costs associated with travelling to the generator sites for maintenance service.

TowerPOWER® produces an electrical power generator which is capable of serving the wireless industry by providing on-site power to cellular base stations. A remote monitoring system, Site-Guard™, is now available with TowerPOWER® generators.

### BRIEF DESCRIPTION OF THE INVENTION

In an exemplary embodiment of the present invention, an electrical power generator for outputting on-site electrical power comprises: an engine, an alternator operatively coupled to the engine, a controller operatively coupled to the engine and alternator for controlling at least one operational parameter relating to the engine or alternator, and a modem operatively coupled to the controller for receiving data from a remote source, the received data being processed by the controller to control the operational parameter.

In another exemplary embodiment of the present invention, a system comprises: a cellular base station for communicating signals with one or more cellular telephones, an electical power generator located on the site of and connected to the cellular base station. The power generator may include an engine, an alternator coupled to the engine, a controller for monitoring and controlling at least one operational parameter of the alternator or engine, and a modem for remotely communicating data relating to the operational parameter of the alternator or engine. The system further includes a processing system remotely located from the power generator and the cellular base station for communicating data with the modem.

In yet another exemplary embodiment of the present invention, a method of remotely controlling a power generator which provides on-site electrical power to a cellular base station comprises: receiving in a modem of the power generator data from a processing system that is remotely located from the power generator, the received data reflecting a command for controlling at least one operational parameter of an alternator or engine of the power generator, and processing the received data and controlling the operational parameter of the alternator or engine of the power generator in accordance with the received data.

In yet another exemplary embodiment of the invention, a method of remotely controlling first and second on-site power generators using the same processing system comprises: receiving in a first modem of the first power generator data from the processing system, the processing system being remotely located from the first power generator, the data received by the first modem reflecting a command for controlling at least one operational parameter of an alternator or engine of the first power generator; and processing the data received by the first modem and controlling the operational parameter of the alternator or engine of the first power generator in accordance with the data received by the first modem. The method further comprises receiving in a second modem of the second power generator data from the processing system, the processing system being remotely located from the second power generator, the data received by the second modem reflecting a command for controlling at least one operational parameter of an alternator or engine of the second power generator; and processing the data received by the second modem and controlling the operational parameter of the alternator or engine of the second power generator in accordance with the data received by the second modem.

### BRIEF DESCRIPTION OF THE DRAWINGS

These, as well as other advantages of this invention, will be more completely understood and appreciated by careful study of the following more detailed description of the presently preferred exemplary embodiments of the invention taken in conjunction with the accompanying drawings, in which:

FIG. 1 is a diagram illustrating a cellular telephone system including at least one cellular base station which receives electrical power from a remotely controlled on-site electrical power generator in accordance with an exemplary embodiment of the present invention;

FIG. 2 is a high level-top view diagram of a power generator illustrated in FIG. 1 showing at least some components thereof;

FIG. 3 is a perspective view of a power generator for providing electrical power to a cellular base station in accordance with an exemplary embodiment of the present invention;

FIG. 4 is a side view of the power generator illustrated in FIG. 3;

FIG. 5 is a back view of the power generator illustrated in FIG. 3;

FIG. 6 is a perspective view of the power generator illustrated in FIG. 3 being lifted;

FIG. 7 is a perspective view of the power generator illustrated in FIG. 3 being moved using a pallet;

FIG. 8 is a top view of an exemplary engine which forms a part of the power generator in accordance with an exemplary embodiment of the invention;

FIGS. 9A-9C are views illustrating an exemplary alternator which forms a part of the power generator in accordance with an exemplary embodiment of the invention;

FIG. 10 illustrates a front control panel including an exemplary controller which forms a part of the power generator in accordance with an exemplary embodiment of the present invention;

FIG. 11 is a more detailed view of the controller of the front control panel illustrated in FIG. 10;

FIG. 12 is a computer video screen display of a computer system in remote communication with the power generator representing a control panel allowing a user to review data and input commands to control the power generator in accordance with an exemplary embodiment of the invention;

FIG. 13 is a computer video screen display of a computer system in remote communication with the power generator allowing the user to select the language that contents of other screens will be displayed in accordance with an exemplary embodiment of the invention;

FIG. 14 is a computer video screen display of a computer system in remote communication with the power generator illustrating various readings of operational parameters of the power generator in accordance with an exemplary embodiment of the invention;

FIG. 15 is a computer video screen display of a computer system in remote communication with the power generator illustrating various input and output states of the power generator in accordance with an exemplary embodiment of the invention;

FIG. 16 is a computer video screen display of a computer system in remote communication with the power generator illustrating an alarm condition of the power generator in accordance with an exemplary embodiment of the invention;

FIG. 17 is a computer video screen display of a computer system in remote communication with the power generator which allows a user to set a day and time for a an automatic test of the power generator to be performed in accordance with an exemplary embodiment of the invention;

FIG. 18 is a computer video screen display of a computer system in remote communication with the power generator illustrating recorded events relating to operation of the power generator in accordance with an exemplary embodiment of the invention;

FIG. 19 is a computer video screen display of a computer system in remote communication with the power generator illustrating information relating to the tele-control of the power generator in accordance with an exemplary embodiment of the invention;

FIG. 20 is a computer video screen display of a computer system in remote communication with the power generator illustrating a settings window for a modem of the power generator in accordance with an exemplary embodiment of the invention;

FIG. 21 is a diagram illustrating remote communication between modems of the power generator and computer system in accordance with an exemplary embodiment of the invention;

FIG. 22 is a diagram illustrating remote wireless communication between a power generator having a GSM modem and a computer system or cellular telephone in accordance with an exemplary embodiment of the invention;

FIG. 23 is a diagram illustrating noise levels of the power generator at various load levels in accordance with an exemplary embodiment of the invention;

FIG. 24 is a diagram illustrating various alarm and pre-alarm connections to a controller of the power generator in accordance with an exemplary embodiment of the invention; and

FIG. 25 is a diagram illustrating, inter alia, an auxiliary battery which may be used to power a modem and controller of a power generator in accordance with an exemplary embodiment of the invention.

### DETAILED DESCRIPTION OF THE INVENTION

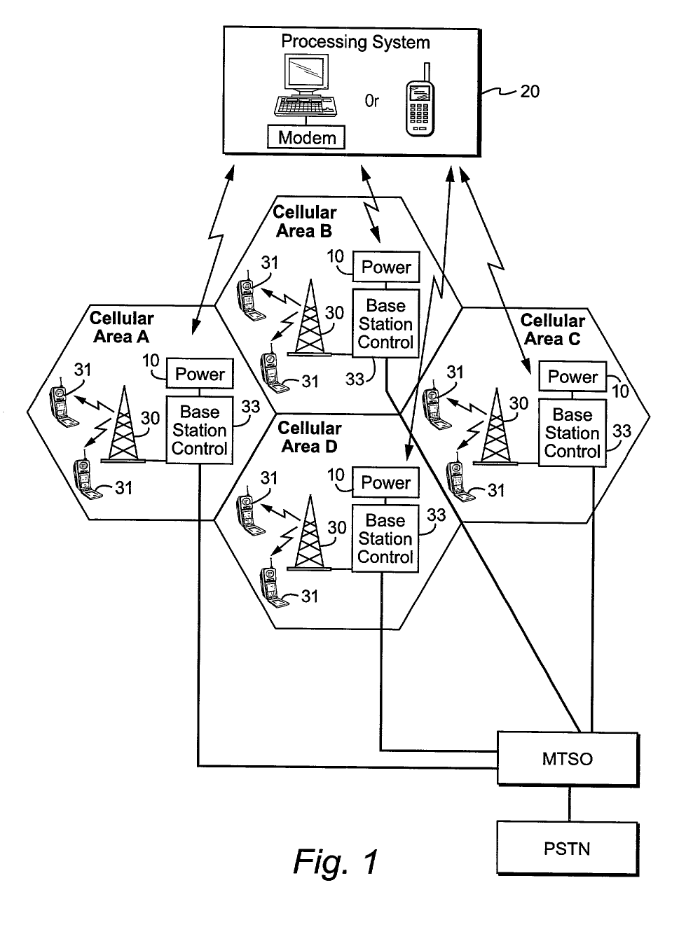

FIG. 1 illustrates a cellular frequency telephone system including a number of cellular base stations 30 each operatively connected to a respective base station control 33. Each cellular base station 30 is located within a respective geographic cellular area and communicates with a central office commonly referred to as a mobile telephone switching office (MTSO) through a base station control 33. The MTSO makes the necessary connections to enable wireless cellular communication between a cellular base station 30 and any cellular telephones 31 located within the same cellular area and communicates signals to/from a channel on the public switched telephone network (PSTN).

Each of the cellular base stations 30 receives electrical power from a respective on-site electrical power generator 10. It will be understood, however, that not every cellular base station 30 must necessarily receive primary power from an on-site power generator. For example, the cellular base station located in cellular areas A and B may receive primary electrical power from an electrical mains infrastructure, while the cellular base stations in cellular areas C and D may receive primary power from respective on-site power generators 10. Any cellular base station that receives primary power from an electrical mains infrastructure may still be operatively connected to a power generator 10 for emergency back-up power. Switches may be used to disconnect the electrical mains power when power generator 10 is switched to connect to the cellular base station. The on-site power generator 10 may thus serve as the primary or secondary source of power to a cellular base station in accordance with an exemplary embodiment of the invention. Cellular base stations located in geographic areas (e.g., rural areas) in which connection to an electrical mains infrastructure is not available may therefore become operable by receiving highly reliable (i.e., limited downtime) electrical power from an on-site power generator 10, thereby helping to satisfy consumer demand for effective cellular phone service over the widest possible geographic region. Highly reliable power to base stations connected to electrical mains power may be ensured through back-up power provided by generator 10.

Each power generator 10 may be monitored, operated and controlled by a processing system 20 (e.g., a computer system having a modem or a cellular telephone) which is remotely located from the power generator 10 and the base station 30. A location that is “remote” from the power generator is one that is at the very least located off-site from the generator. For example, a cellular base station located in cellular area B is “remote” from the power generator and its connected cellular base station located in cellular area A (see FIG. 1).

The power generator 10 and the processing system 20 remotely communicate with each other so that operational parameters of the power generator (e.g., readings, measurements, input/output status, failures, test results, alarms of the power generator) can be remotely reported from the power generator 10 to the processing system 20 for review and evaluation by a user (e.g., power generator technician) and control commands and/or inquires input by the user (e.g., start/stop the power generator, change an operation parameter such as temperature, pressure, voltage, etc.) may be transmitted from processing system 20 to power generator 10 for processing and implementation by the power generator 10.

While FIG. 1 illustrates an exemplary embodiment in which each of power generators 10 remotely communicates with the same processing system 20, the embodiment can be altered so that at least one power generator 10 communicates with another processing system 20. For example, each power generator 10 may be configured (e.g., using communication having different respective frequencies) to remotely communicate with its own separate processing system 20. By enabling remote control of a power generator, a technician may reduce his/her amount of travel to each generator site and still provide effective monitoring and predictive and preventative maintenance control. Furthermore, if one processing system remotely communicates with a plurality of generator sites, a large amount of data may be made available to a highly trained specialist at processing system 20. The specialist may in turn provide any necessary control commands to one or more of the generators.

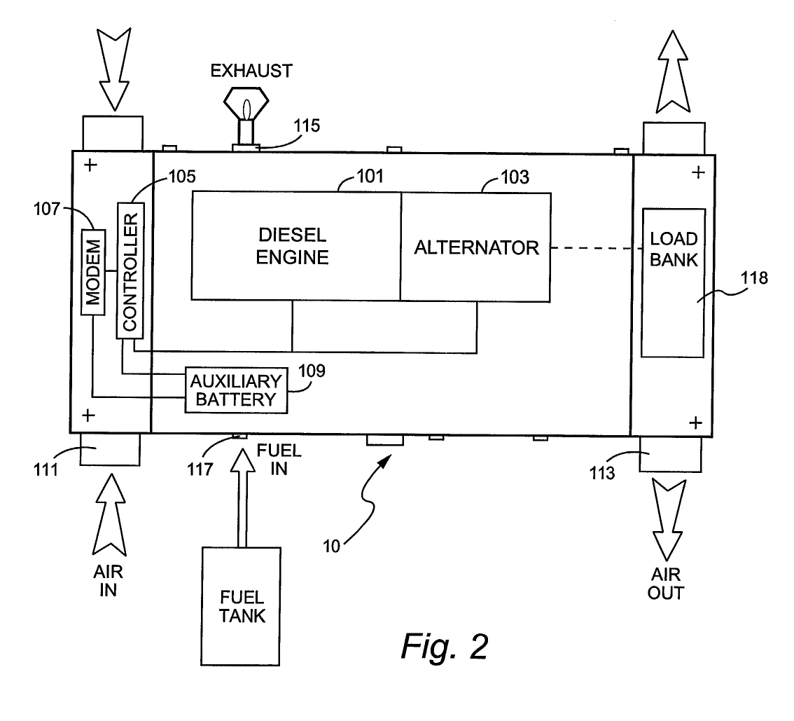

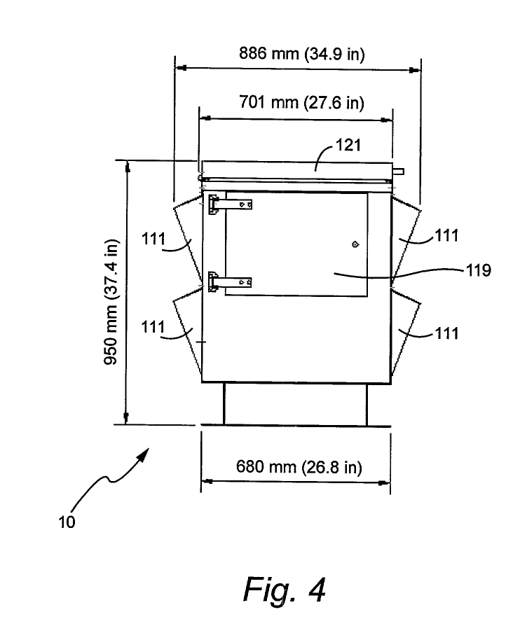

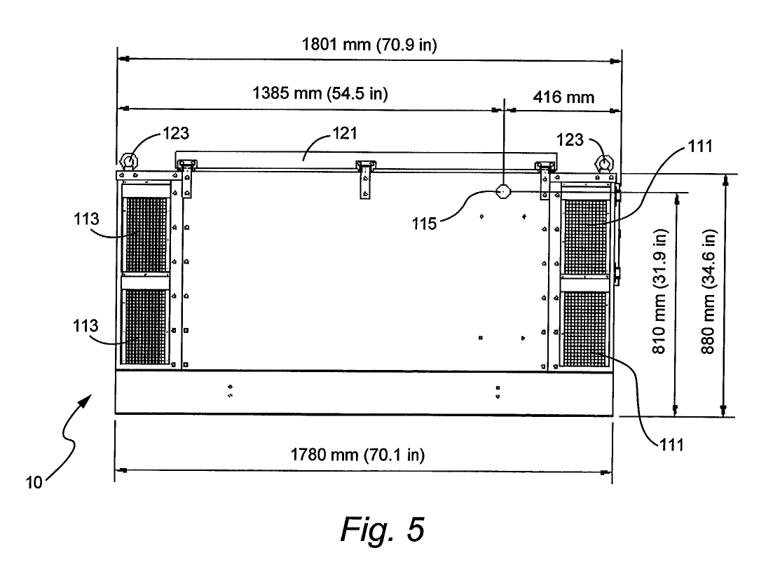

Referring to FIG. 2, the power generator 10 includes, inter alia, an engine (e.g., a diesel engine) 101, an alternator 103, a controller 105 and a modem 107 (e.g., analog modem, GSM modem or internet connection), auxiliary battery 109, air intake vents 111, air outlet vents 113, fuel inlet 117 for receiving fuel from an external fuel tank, exhaust outlet manifold 115, and load bank 118. Controller 105 is operatively connected to engine 101 and alternator 103 and to modem 107. Controller 105 provides/receives signals to/from the engine 101 and alternator 103 and may process any received signals for transmission to the remotely located processing system 20 through modem 107. The signals received by controller 105 from the engine 101 and/or alternator 103 may reflect operational parameters such as readings, measurements, status, test results, alarms relating to, for example, the engine's and/or alternator's temperature, engine's oil pressure, engine's fuel level, battery voltage level, charger failure, engine and/or alternator stoppage, running or starting status of the generator, mains voltage, generator's output voltage, frequency or current level, status (open/closed) of any engine or alternator switch, engine exhaust level, date/time of any conducted test, emergency stoppage, mode of operation, results of load test, etc. The controller is also capable of receiving, processing and remotely transmitting signals from other sensors of the power generator such as sensors indicating the opened/closed status of control panel door 119 (see FIG. 4) or top hatch door 121 (see FIGS. 4-6). These signals may protect generator 10 against theft, vandalism or sabotage.

Controller 105 may receive and process remote commands or inquiries from processing system 20 through modem 107. These commands and/or inquiries may be initiated by processing system 20 or may be received in response to a previous transmission from controller 105. After processing received commands and/or inquiries, the controller 105 may control (e.g., change, test, detect or measure) an operation parameter (e.g., any of the operational parameter(s) of the engine and alternator noted above) of power generator 10.

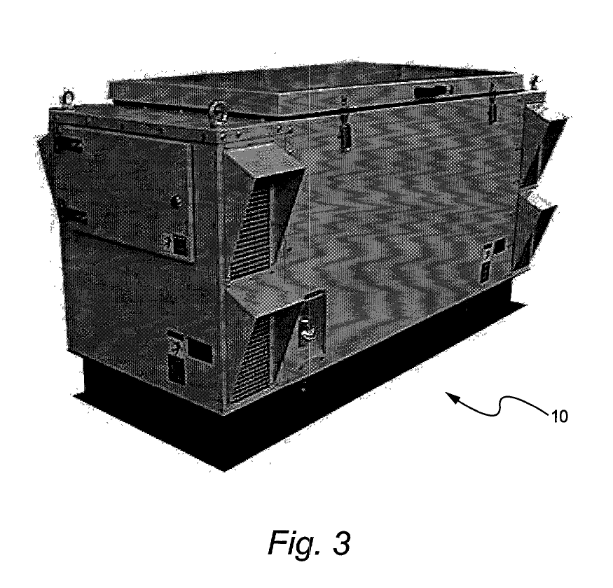

Referring to FIGS. 2-7, an exemplary embodiment of power generator 10 includes a chassis of electrically welded steel for enclosing and protecting, inter alia, engine 101, alternator 103, controller 105, modem 107 and auxiliary battery 109. Vibration absorbers (not shown) may be placed between (a) the engine 101 and alternator 103 and (b) the chassis, and a drip tray may be connected to a sub-base waste tank of the generator.

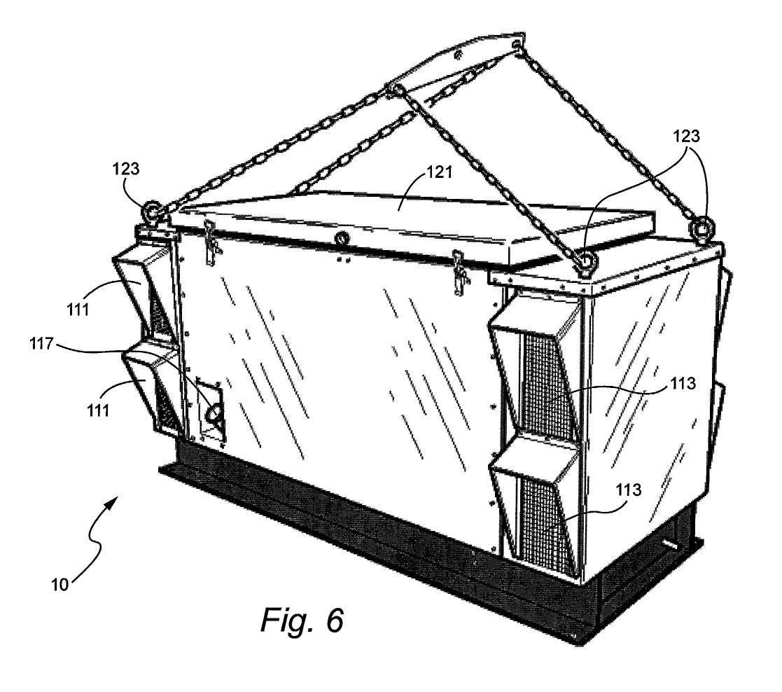

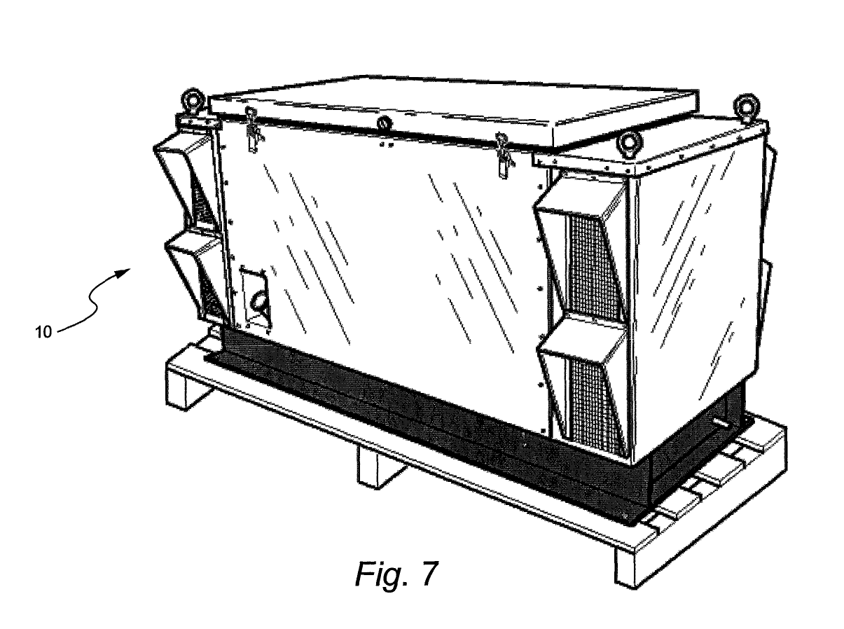

The relatively small unit size (length×height×width of 1800×890×950 mm) and weight (approx. 550 kg) of power generator 10 allows it to be easily transported by lifting it using handling rings 123 (see FIG. 6) or moving it with a pallet (see FIG. 7) and quickly installed at the generator site. The relatively easy transport and installation of power generator 10 is particularly beneficial when the terrain leading to or at the generator site is rough.

General technical specifications of an exemplary embodiment of power generator 10 may include the following:

Limited Time Power (L.T.P.)=10 kVA cost=1

Continuous Operating Power (C.O.P.)=9 kVA cosp=1

Voltage=230 V single-phase

Amperage=43.5 A

Frequency=50 Hz

Rotational speed=1500 rpm

Fuel type=automotive diesel fuel

Engine mfg.=Lombardini

Engine model=LDW CHD 1503

Engine max power at 1500 rpm=13.5 kW

Engine displacement=1551 cc

Cylinders=3

Cooling system=water

Alternator mfg.=Meccalte

Alternator model=ECO 28 S/4

Alternator type=4 poles brushless with avr

Dimensions (1×w×h)=1800×890×950 mm

Sound level @ 7 m (75% C.O.P. rating)=<70 dBa

Dry weight (kg.)=approximately 550 kg

Protection=IP 33.

FIG. 8 illustrates an exemplary engine 101 that may be utilized as part of power generator 10. The engine may be, for example, a diesel powered engine and may include an enlarged lube oil sump 1011 (e.g., at least 11 liters) and fuel tank to extend the time between maintenance inspections/services. Specifically, the enlarged oil sump 1011 and fuel tank of an exemplary embodiment of the invention provides a time interval of six weeks between maintenance services. This interval may be maintained or even further increased through the use of an automatic lube oil top up tank.

Technical specifications of an exemplary engine 101 that may be used as part of generator 10 may include the following:

Make=Lombardini

Type=LDW CHD 1503

Rotation speed=1,500 r.p.m.

Maximum power=13.5 kW at 1,500 r.p.m.

Cycle of the engine=4-cycles

Type of injection=IDI

Number and configuration of cylinders=3 in line

Bore=88 mm

Stroke=85 mm

Valve system=maintenance free hydraulic valve lifters

Mean linear piston speed=4.25 m/s

Displacement=1.55 liters

Type of cooling=water

Fuel consumption

at full load=4.6 liters/hour

at ½ load=2.5 liters/hour

at ¼ load=1.2 liters/hour

Oil consumption=0.006 liters/hour

Exhaust gas emission: =per directive 97/68 EEC phase 2

Climatic Conditions of Engine

ambient temperature:

max: 50° C.

min: −20° C.

derating: −2% for every 5° C.

above 20° C.

relative humidity: max: 90%

altitude: engine rated power is at sea level derating: −1% for every 100 m above sea level

Characteristics of Engine Liquids

Fuel: standard automotive diesel fuel

Oil: API—CD

Grade:

ambient 20° C. to 50° C.: SAE 40

ambient 0° C. to 20° C.: SAE 20

ambient −20° C. to 0° C.: SAE 10

Coolant: Mixture:

50% ethylene glycol antifreeze

50% demineralized water

Cooling of Engine

maximum ambient temperature: 50° C.

fan driven by water pump—alternator belt

high-temperature water alarm

low water level alarm

thermostatic valve

Preheating of Engine

as IDI the engine is glow-plugs equipped for low temperature easy starting

Starter of Engine

electrical 12 Volt starter on the gear ring of the engine's flywheel

12 Volt lead battery with a capacity of 80 Ah

Speed Regulation of Engine

type: mechanical (engine integrated)

rate of regulation under established conditions: ±3

Exhaust of Engine

primary muffler inside the enclosure

final outside protected super quiet muffler

Coupling of Engine

semi-rigid coupling by flanged mounting on single-bearing alternator

Lubrication of Engine

spin-on cartridge oil filter—

12.7 liters total capacity oil sump

11.7 liters total oil volume before low pressure alarm

oil level warning when oil volume is 2.1 liters before low pressure alarm

manual drain pump

Air Intake of Engine

cartridge-type dry air filter

Fuel of Engine

10 micron spin-on cartridge primary fuel filter with:

water separation system

transparent bowl for visual water checking

electrical detection of water and warning

3 micron spin-on cartridge final fuel filter

electro-valve on the fuel circuit for:

stopping the engine normally stopping when a safety device has tripped

mechanical lift pump up to 1.5 m head

fuel system provided for external sub-base tank

Sensors of Engine

low engine oil pressure (alarm)

low oil level in the sump (warning)

engine cooling high water temperature (alarm)

approaching engine cooling high water temperature (warning)

engine cooling circuit low water level (alarm)

Service and Maintenance Intervals of Engine

1000 h:

oil replacement

oil filter replacement

primary and final fuel filter replacement

fan belt check

air filter check

2000 h:

fan belt replacement

air filter replacement

In order to enable power generator 10 to generate the necessary electric power to operate a cellular base station, engine 101 drives a rotor of alternator 103 within its stator under the monitoring and control of controller 105. The electrical output of the alternator may then be transformed as necessary for application to the cellular base station.

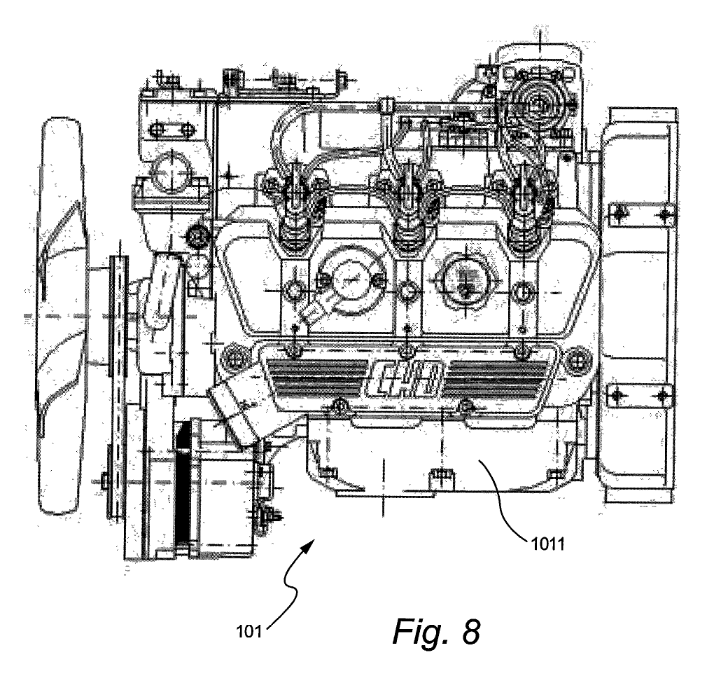

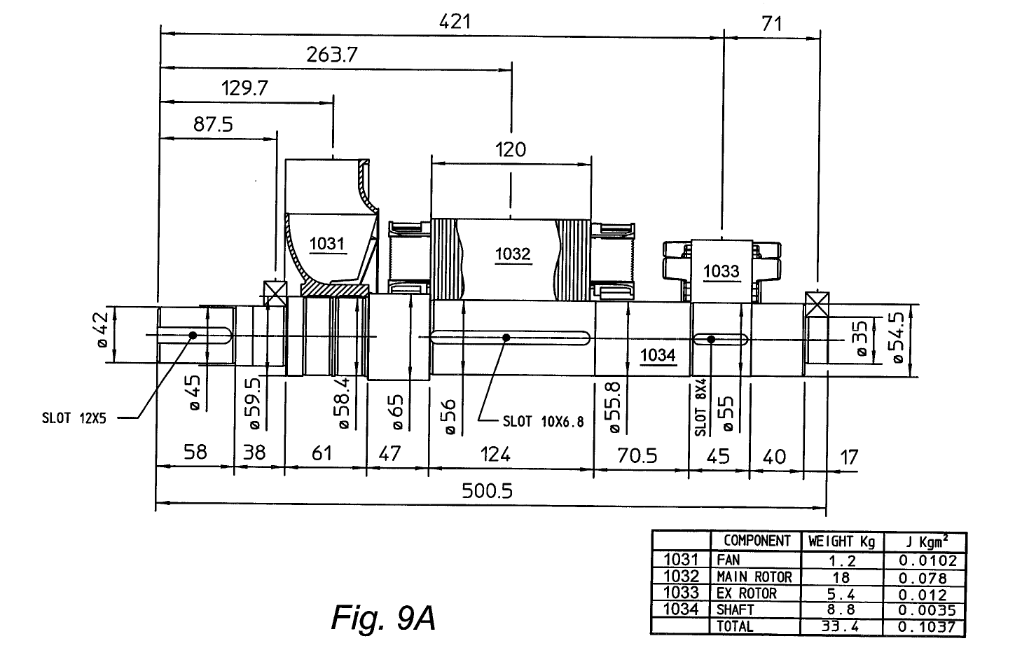

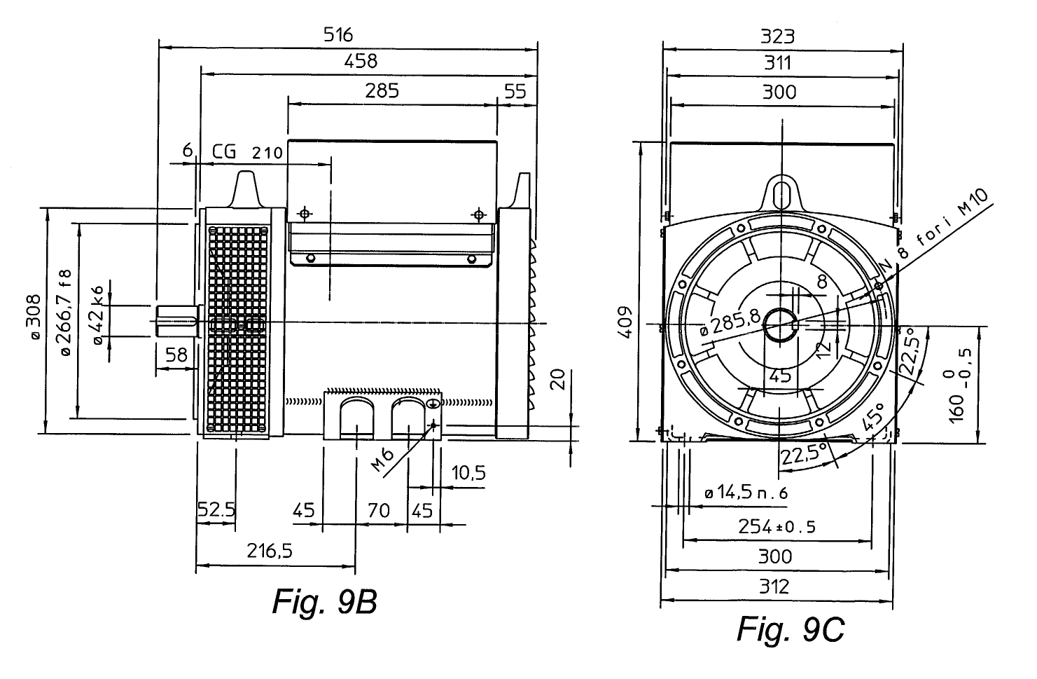

FIGS. 9A-9C illustrate an exemplary alternator 103 with exemplary dimensions including fan 1031, main rotor 1032, exciter rotor 1033 and shaft 1034. Technical specifications of an exemplary alternator 103 that may be used as part of generator 10 may include the following:

General Description of Alternator

make=Meccalte

type=ECO 28 S/4

rotation speed=1,500 r.p.m.

poles=4

rated power

=16 kVA @ H class 3 ph 400V 50 Hz PF=0.8

=10.5 kVA @ H class 1 ph 230V 50 Hz PF=1

type of connection=Delta connection single phase 230V rated voltage

ECO 4 pole alternators may be brushless, self-regulating and incorporate a rotating inductor with damper cage winding and a fixed stator with skewed slots. The stator windings may have a shortened pitch to reduce the harmonic content of the output waveform.

The casing of the alternator may be made of steel, the shields of cast iron, and the shaft of C45 steel. The shaft may have a keyed fan. All rotating components may be epoxy resin impregnated, and higher voltage parts such as the stators may be vacuum-treated.

### Electrical Characteristics of the Alternator (@50 hz 230/400v)

Regulation with SR7/2=+1.5% with any power factor and speed variations between −5% +30%

Efficiencies (class F 15 kVA 3 ph)=

4/4% 83.3

3/4% 84

2/4% 83

1/4% 81.4

Reactances (class F 15 kVA 3 ph)

Xd % 196

Xd′ % 16.9

Xd″ % 11.5

Xq % 72

Xq′ % 72

Xq″ % 24

X2% 17

X0% 3.6

Short Circuit Ratio=Kcc 0.67

Time Constants=

Td′ sec. 0.051

Td″ sec.=0.018

Tdo′ sec.=0.90

Ta sec. 0.016

Short Circuit Current Capacity=% >300

Excitation at no load Amp.=0.5

Excitation at full load Amp.=1.7

Overload (long-term)=1 hour in a 6 hours period 110% rated load

Overload per 20 sec.=% 300.

Stator Winding Resistance (20° C.)=Ω0.424

Rotor Winding Resistance (20° C.)=Ω1.26

Exciter Resistance (20° C.)=

Ω Rotor: 0.640

Stator: 10.60

Heat dissipation at f.l.cl.F=2406 W

Telephone Interference THF=<2% TIF<45

Radio interference=VDE 0875 N.

Waveform Distors.(THD) at f. load LL/LN=% 2/2

Waveform Distors.(THD) at no load LL/LN=% 3.7/3.7

Mechanical Characteristics of Alternator

Protection=IP 23 M

DE bearing=6309-2RS

NDE bearing=6207-2RS

Weight of wound stator assembly=kg 33.2

Weight of wound rotor assembly=kg 18

Weight of complete generator=kg 108

Maximum overspeed=rpm 2250

Unbalanced magnetic pull at f.l.cl.F=kN/mm 3

Cooling air requirement=m³/min 5.3

Inertia Constant (H) sec.=0.08

Noise level at 1 m/7 m=dB(A) 68/57

AVR Protections of Alternator

SR7 regulators may be provided with an under-speed protection with an intervention threshold which can be adjusted by the potentiometer marked “Hz”. This protection intervenes instantaneously by reducing the alternator voltage to a safe value when the frequency falls below 10% of the nominal value. These regulators may also have inherent overload protection which senses the exciter field voltage value. Should this field voltage value exceed the nominal value for a period of more than 20 seconds, then the alternator voltage is automatically reduced to a safe operating level. This overload function has a built-in delay to allow for the overload when starting motors (normally 5-10 seconds). The operating threshold of this protection device is adjustable by the potentiometer marked “AMP”.

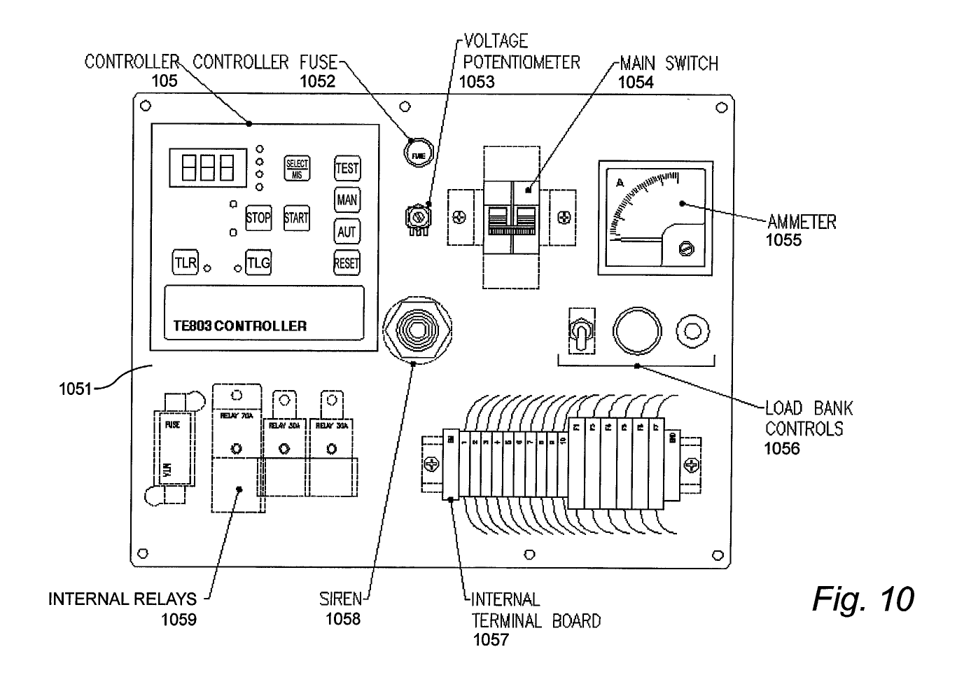

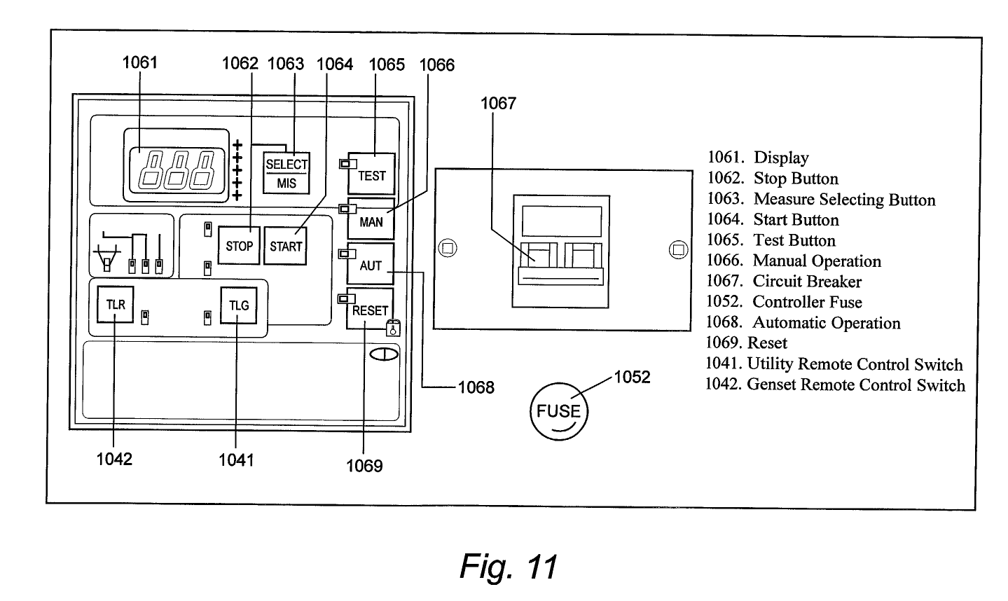

FIG. 10 illustrates a controller panel 1051 including a front panel of controller 105 (also labeled “TE803 CONTROLLER”), controller fuse 1052, voltage potentiometer 1053, main switch 1054, ammeter 1055, load bank controls 1056, internal terminal board 1057, siren 1058 and internal relays 1059. As discussed above, controller 105 enables power generator 10 to be remotely monitored by a user at processing system 20 through data transmitted from controller 105 through modem 107. Controller 105 also allows power generator 10 to be remotely controlled through data signals received from processing system 20. However, in addition to this remote control, controller 105 also allows power generator 10 to be manually controlled on-site through control buttons/switches 1062-1069, 1041-1042 (FIG. 11) provided on the front panel of controller 105. The front panel of controller 105 also displays results of any reading, measurement, test, alarm, etc. relating to an operational parameter of the power generator on display 1061 and/or other LEDs. As discussed above, data reflecting the results may also be transmitted to processing system 20. Input can be provided at processing system 20 or at the control panel of controller 105 to determine whether on-site input at the control panel 1051 or remote input at processing system 20 is given precedence over the other for a given time. The front panel of controller 105 may be accessed by a technician by unlocking and opening door 119 (FIG. 2).

Technical specifications and characteristics of an exemplary controller 105 which forms a part of generator 10 may include the following:

### Controller Main Features

Control based on 11 MHz Intel 80c552 microprocessors.

32 Kbyte EPROM memory program

32 Kbyte static RAM data memory

512 Word EPROM nonvolatile data memory

Operator display of 3 figures LED display

Function/State/Alarm display by means of 15 LED's

Diaphragm button strip with 7 mechanical effect buttons

Voltages measure at real effective value (RMS.)

All programming options accessible from the frontal side without dip switch (by software in permanent memory)

Programming options protected by admittance key

“Intelligent” modulation of voltage and current control of battery charger

RS 232 serial interface for remote control by computer or modem

Description of Panel of Controller

Reset/Manual/Auto/Test buttons 1069, 1066, 1068, 1065 (see FIG. 11) (to select operating procedures)

Measure button 1063 (to select display)

Start/Stop buttons 1062, 1064 (to start/stop the generator)

Reset/Man/Auto/Test LED (selected operating procedure signals)

LED volt, hertz, V. Battery, hour meter (selected measure signals)

LED battery (battery charger condition)

LED starting failure (Generator starting failure)

LED engine on (Generator on)

LED alarms (alarms on)

LED TLR (utility mains), TLG (Generator AC power leads) indicates power source being delivered to the load

LED failure (fault/alarm signal)

3 figure display 1061 (display of measures, alarms, etc.)

Terms and Procedures of the Controller

PROGRAMMING: Programming is the set up of the controller. This is done before or during the installation of the generator. All operating times and calculations that affect the system functioning can be set up and the parameters may be stored in a permanent memory. Only authorized trained personnel can reach this password protected function. “Options” (another type of parameters), on the contrary, can be adjusted at any time without a password.

STARTING CYCLE: The sequence of generator starting is as follows: First glow-plugs are energized (programmable duration), then the fuel solenoid valve is activated. After these two steps, the control panel enters into a start interval (programmable duration) alternating with intervals of cool down (programmable duration). Once the engine is on, the starting attempts stop immediately. The siren relay is activated before starting up the engine (due to an automatic start—test or to an external start). This will help maintenance technicians realize that the group is going to be started.

GENERATOR STOPPING PROCEDURE: The transfer switch (if present) opens and the generator continues to run for a programmable cool down period at the end of which a fuel solenoid valve opens and the engine stops. In case of an emergency stoppage, the above mentioned procedure takes place without considering the cool down time.

ENGINE ON: The engine is on when the “engine ON” signal, which comes out of the engine alternator exceeds the fixed voltage or programmed value. Its LED shows the engine-on signal.

ALARMS ON: Oil pressure and high temperature alarms are connected after a delay time (programmable) greater than the engine-on signal time. To stress that, the “engine ON” LED becomes flashing when the engine is on but the alarms are not enabled, and becomes steadily lit (on) when the engine is running and the alarms are enabled. During the stopping cycle, the alarm is disabled and the fuel solenoid valve simultaneously closes.

GENERATOR-ON: The generator-on signal occurs when the generator voltage is not out of the fixed limits (lower than the minimum fixed voltage or higher than the maximum fixed voltage) and remains in that state for a programmable time.

UTILITY/GENERATOR AND GENERATOR/UTILITY SWITCHING: In case of mains utility presence (i.e., in case both a mains power and an on-site generator 10 may be utilized to power the cellular base station), the remote control switches between the utility and generator. A delay time occurs to avoid simultaneous connections.

Description of Display of Controller

The following measures can be selected on the display 1061 (FIG. 11):

Utility/Generator voltage (Volt)

Frequency of Generator signal (Hertz)

Battery voltage (Vdc)

Generator working hours (hour meter)

A light also signals which measurement is being displayed (AC volts, frequency (Hertz), Battery Vdc, run hours). Another measure on the display may be selected by pressing the measure button 1063. When a technician selects a voltage measure and the generator is off, display 1061 will show a utility voltage. The displayed value of utility and generator voltage is in 1 volt increments, the frequency at 0.1 Hz, the battery voltage at 0.1 volt and working hours at 1 hour (even if the internal time stored is measured in minutes). The controller may display RMS voltage measurements and at the same time, accurately and quickly control all functions needed for the proper operation of the generator.

Operating Procedures of Controller

Controller 105 may perform 4 different functions: reset, automatic, manual and test (described in detail below). After a procedure is selected, its button and its corresponding LED lights up. It may be possible to skip from one operating procedure to another. After controller power-up, the operating procedure may become RESET. When one of the four operating procedures' (reset, automatic, manual, test) corresponding LED is flashing, the unit is being controlled by remote control.

RESET PROCEDURE: When using the reset operating procedure, the controls are not operational. All displayed alarms may be set to zero as if the unit was not connected. Only the general alarm is still in operation. Control entries and the siren alarm are disconnected as well. Signaling LED's, on the contrary, remain in operation and can show measures and alarms. When Man/Auto/Test is changed to reset and the generator is in operation, the controller may stop the generator automatically without waiting for the cooling interval.

AUTOMATIC PROCEDURE: In the sutomatic procedure mode, the generator starts when the utility voltage goes out of limits and its respective control switch is off. After a programmed delay, utility remote control switch is switched off and the generator start cycle begins. When the generator is running and its voltage reaches the fixed limits, the generator remote control switch closes. The generator continues working until the utility voltage is restored. Once the utilities are back, the remote control switches exchange position and the generator carries out the stop cycle. When the generator is running, however, it can be stopped by means of the stop button 1062. In the automatic procedure mode, both the remote start and stop are enabled.

MANUAL PROCEDURE: In the manual procedure mode, the generator can be started or stopped simply by pushing the respective start and stop buttons 1064, 1062 (FIG. 11). Start button 1064 begins the start cycle while stop button 1062 begins the stop cycle. After pushing stop button 1062, the stop cycle can be stopped from beginning by immediately pushing start button 1064. By pressing (and holding) the manual button 1066 and the TLG (generator) button 1041, a technician can switch power from utility (mains) power to generator power. Power can be switched from generator to utility (mains) power by pressing and holding manual button 1066 and TLR (Utility) button 1042. From one button pressing command to another, an interval delay takes place as previously programmed. Passing from auto to test or manual does not affect the operation of the generator.

TEST PROCEDURE: In the test procedure mode, the generator begins the start cycle. If the utility (mains) power drops out while the generator is in a test mode, the controller will override this function and switch the generator to the load. Once the utility voltage returns, the load will stay on the generator. If the auto mode is enabled, the controller will transfer the load to the utility and will start the stop cycle of the generator.

AUTOMATIC TEST PROCEDURE: The automatic test procedure is a periodic check that is performed by the control panel at fixed intervals (interval can be fixed during option setup). If the control panel is in automatic mode and the automatic test has been enabled, the generator runs for a fixed period before it stops.

WORKING HOUR CALCULATION: After the engine has started, the working minutes are counted. The calculation, expressed in hours, can be shown on display 1061. The calculation continues even if the electrical input is disconnected and cannot be set to zero by the user.

PERIODIC MAINTENANCE INTERVAL: Through set up, a periodic maintenance interval, expressed in hours, is set. When the number of working minutes reaches the fixed amount, the display shows the code of maintenance request. The control panel, however, continues to work normally. Pushing reset button 1069 allows the calculation to be set to zero and the message disappears.

Description of Alarms Provided by Controller

Display 1061 and other LEDs (FIG. 11) of controller 105 may show certain codes to signal an emergency or other specific situation to an on-site technician. Additionally or alternatively, data reflecting the emergency or other situation may be remotely transmitted by controller 105 to processing system 20 via modem 107. A technician at processing system 20 may them review the data off-site from generator 10 and then, if necessary, input instructions into processing system 20 for transmission back to controller 105 through modem 107. Controller 105 may then process these received signals and modify an operational parameter of generator 10 accordingly. The message that is displayed on display 1061 and/or transmitted to processing system 20 disappears only when the emergency condition or situation has disappeared and the user has pressed the reset button 1069 or transmitted a reset command from processing system 20.

The following codes may be displayed by the panel of the controller 105 and/or transmitted to the processing system for display:

A01 Temperature Alarm:

The temperature alarm message appears when, during engine operation, the temperature sensor detects an over temperature condition. In this case the generator remote control switch opens and the generator stops at once.

A02 Oil Pressure Alarm:

The oil pressure alarm operates like the temperature alarm mentioned above, but it refers to the sensor for insufficient oil pressure.

A03 Charger Alternator Failure Alarm:

The charger alternator failure alarm appears when the generator is running and the generator voltage is within limits, but the battery charger alternator signal is missing (lower than setup −06 for more than setup −14 time delay).

A04 Mechanical Alarm

The mechanical alarm indicates that the engine is not operating for a non-electrical problem.

A05 Request for Maintenance

This request for maintenance alarm occurs when the periodic maintenance interval has been exceeded. This interval (in hours) is programmed in the setup menu. The generator, however, continues to work normally.

A06 Runaway Speed Alarm

The runaway speed alarm occurs when frequency (Engine RPMs) exceeds the value fixed by setup. The transfer switch opens and the generator stops immediately.

A07 Fuel Alarm

The fuel alarm indicates low fuel level.

A08 Door Interlocks

The door interlocks indicator signals that one of the generator doors (e.g., doors 119, 121) has been opened. This may be programmed as an indication only.

A09 Prealarms

The prealarm indicates that one of the controlled parameters is going to alarm condition. This may be programmed as indication only.

A10 Starting Failure

An occurrence of starting failure is displayed when the number of starting attempts are performed and the engine is not yet running.

A11 Generator Under Frequency

The generator under frequency code activates when, with the alarms on (the motor running for longer than the alarm delay) the generator frequency is less than the minimum frequency alarm threshold that lasts longer than the generator voltage absence delay.

A12 Low Battery Voltage

The low battery alarm is displayed when battery voltage is below the low battery voltage alarm threshold.

A13 High Battery Voltage

The high battery alarm is activated when the battery voltage increases over the maximum battery voltage alarm threshold.

E01 Emergency Stop

The emergency stop message is displayed when the technician stops the generator by pushing the stop button or the emergency stop button in automatic or test procedures.

E04 Generator Voltage Failure

The generator voltage failure alarm occurs when, with engine running, the generator voltage goes out of the programmed voltage and time limits.

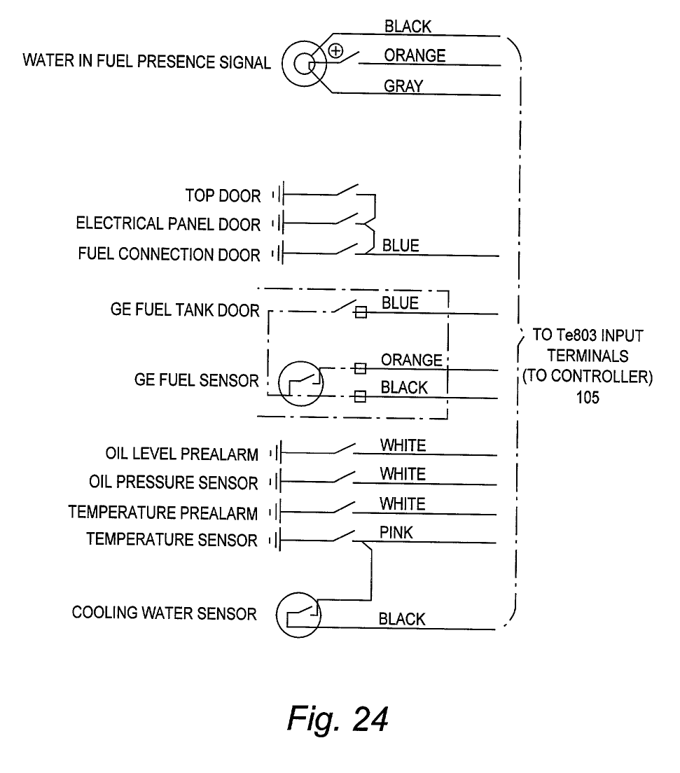

FIG. 24 illustrates exemplary alarm and pre-alarm connections to controller 105. The connections of alarms and pre-alarms to controller 105 may include the following:

Water Temperature Alarm

Oil Pressure Alarm

Charger Alternator Failure Alarm

Mechanical Failure

Request for Maintenance

Runaway Speed Alarm (over speed)

Fuel Level

Low Water Level

Start Failure

Min. Frequency

Min. Battery Voltage

Max. Battery Voltage

Emergency Stopping On

Generator Voltage Failure (out of limits)

Approaching water temperature (pre-alarm)

Approaching low oil level (pre-alarm)

Water presence in diesel fuel (pre-alarm)

The activation of one of the above 3 pre-alarms initiates a call by controller 105 through modem 107 for the service. In this way, technicians can operate on the generator on time and avoid failures.

### Description of Exemplary Technical Features of Controller

Supply Circuit

Battery Supply (US)=12 Vdc

Maximum Current Consumption=160 mA (250 mA with rs485)

Stand-by Current=110 mA (250 mA with rs485)

Operating Range=12V 6.2-16.5 Vdc

Immunity Time for Micro breaking=−150 ms

Maximum Ripple=10%

Mains Voltage Control Circuit

Rated Voltage (UE)=100-480 VAC

Operating Range=60 Hz

Rated Frequency (Keyboard Adjusted)=0.7-1 UE

Minimum Voltage Tripping (Keyboard Adjusted)=1-1.5 UE

Generator Voltage Control Circuit

Rated Voltage (UE)=100-480 Vac

Operating Range=70-624 Vac

Rated Frequency (Keyboard Adjusted)=60 Hz

Minimum Voltage Tripping (Keyboard Adjusted)=0.7-1 UE

Maximum Voltage Tripping (Keyboard Adjusted)=1-1.5 UE

Started Engine Control Circuit

Battery Charger Permanent Magnet Alternator=0-40 Vac

Operating Engine=6-30 Vac

Battery Charger Energized Alternator

Operating Range=0-40 Vdc

Adjustment Range=6-30 Vdc

Circuit Voltage=12 Vdc Battery

Output Relay Contacts to Exclude Mains and Generator: −Common Alarm Relay (Fault Relay) 1 NO/NC Contact (SPDT).

As illustrated in FIG. 2, generator 10 includes a load bank 118. In order to avoid carbon deposits inside the exhaust manifold 115 on the engine in case of continuous no load or almost no load operation, the load bank 118 has been designed to automatically load generator 10 with for example a 5 kW ventilated resistive load for 15 minutes every 3 hours when the output is less then 4 kW. When the requested load is more than 4 kW the load bank is automatically disconnected. Accordingly, load bank 118 may be connected/disconnected to receive an output originating from alternator 103 to impose a load on generator 10. Load bank 118 may be formed by, for example, one or more heaters, and may be controlled through load bank controls 1056 (FIG. 10). Data related to the automatic loading by load bank 118 may be transmitted to processing system 20.

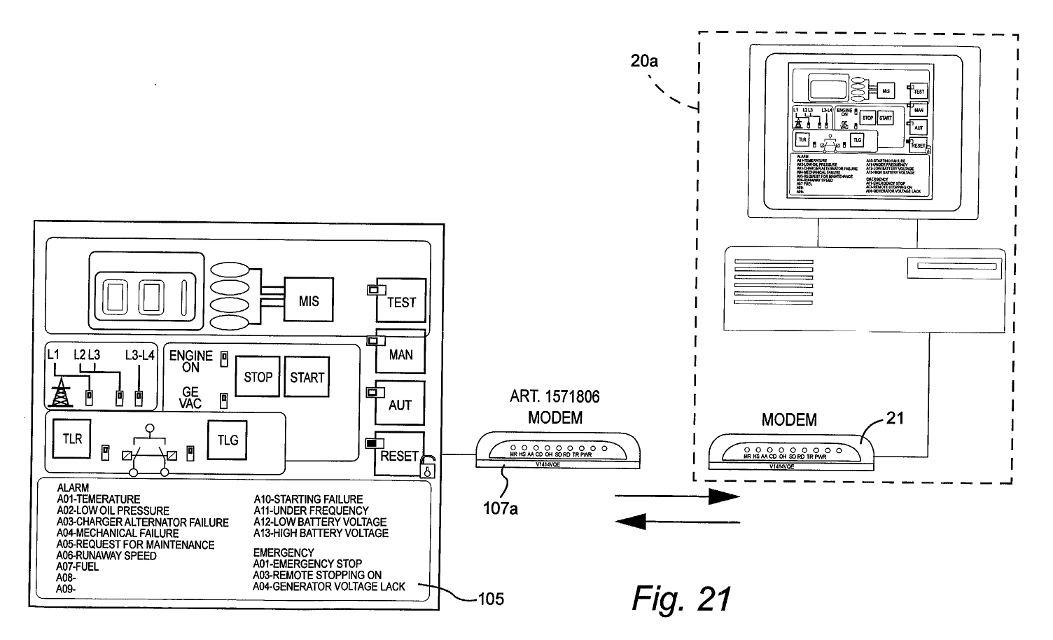

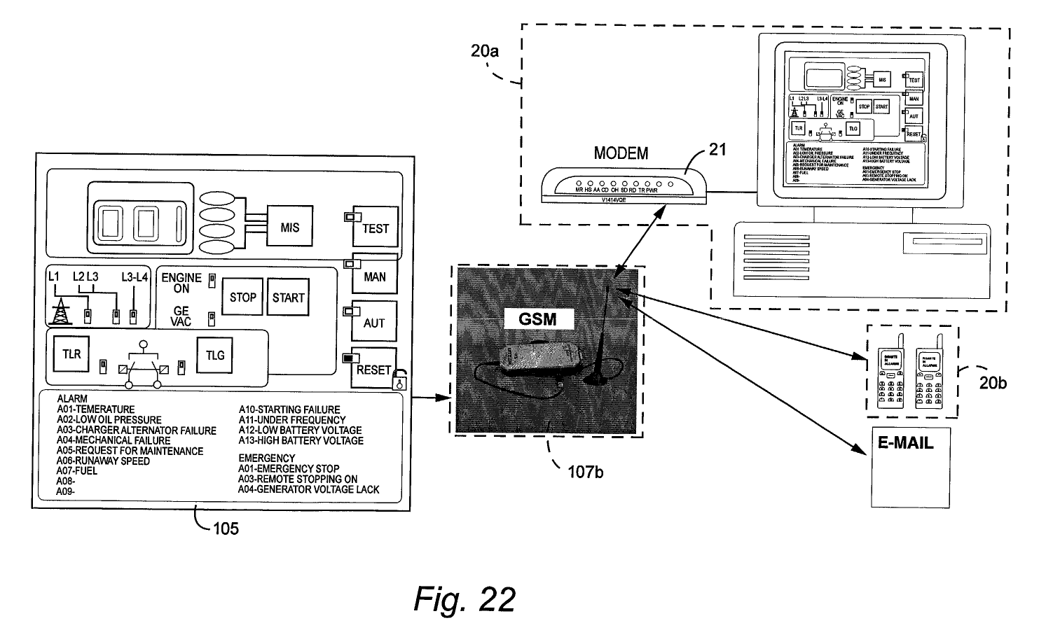

As discussed above and with further reference to FIGS. 21-22, controller 105 can remotely communicate data signals relating to operational characteristics of the power generator 10 through modem 107. Modem 107 may be formed by, for example, a modem 107a (see “ART 1571806” in FIG. 21) or a GSM modem 107b (FIG. 22). Processor system 20, which communicates with controller 105 via modem 107, may be formed over, for example, a computer system 20a including modem 21 (FIGS. 21-22) or a cellular telephone 20b (FIG. 22). Communication between modems 107a and 21 may be established on-line by, for example, a LAN or WAN such as the internet. The GSM modem 107b is capable of wireless transmission/reception of data to/from processing system 20 (e.g., computer system 20a or cellular phone 20b).

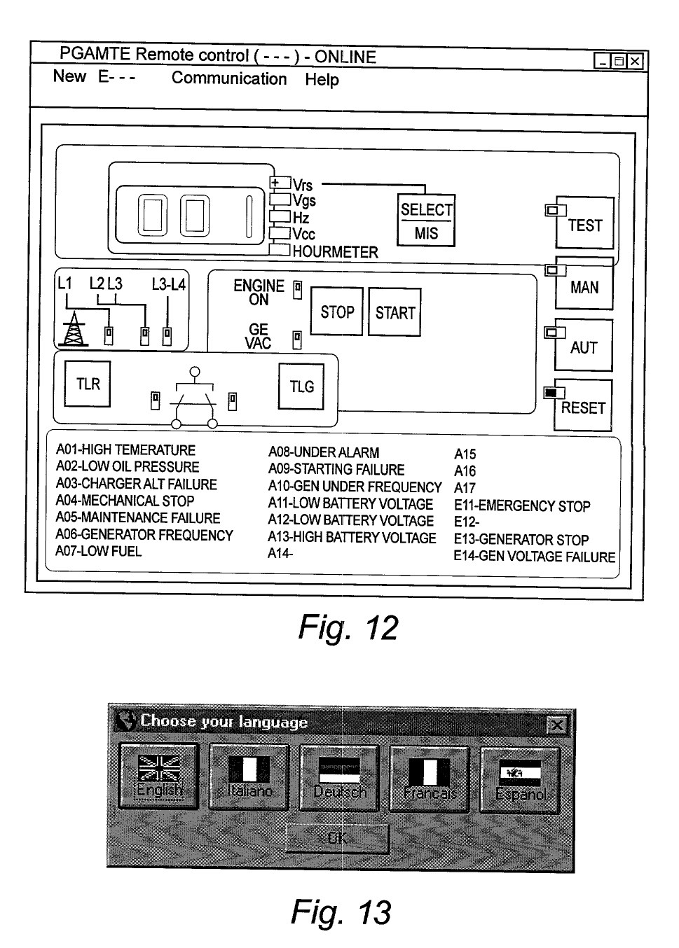

The computer system 20a, as an exemplary processing system 20, is capable or generating video screens to allow a computer user to review data (e.g., readings, measurements, test results, alarms, etc.) relating to operation of the power generator and to input commands and/or inquiries for transmission to the controller 105. FIGS. 12-20 illustrate exemplary screens (i.e., on-line windows) that may be displayed by the computer system 20a so that a user can perform on-line monitoring, evaluation and control of power generator 10. Screens for data display and command/inquiry input may be similarly provided by the display screen of cellular phone 20b.

FIG. 12 illustrates an image of a video screen that closely resembles the front panel of controller 105. Since this image closely resembles the front panel of controller 105, a technician who is familiar with controlling the generator on-site using the front panel of controller 105 can easily become familiar with controlling the generator using the computer system 20a (or vice versa). A user at the computer system 20a can review data and input commands through the a mouse or keyboard. For example, a user may input commands to: start the generator, stop the generator, run a test, exchange/switch a contact, initiate a measurement, or sense signs of alarm and emergency.

FIG. 13 is a video screen that may be displayed by computer system 20a which allows a user to select in which language other screens are to be presented.

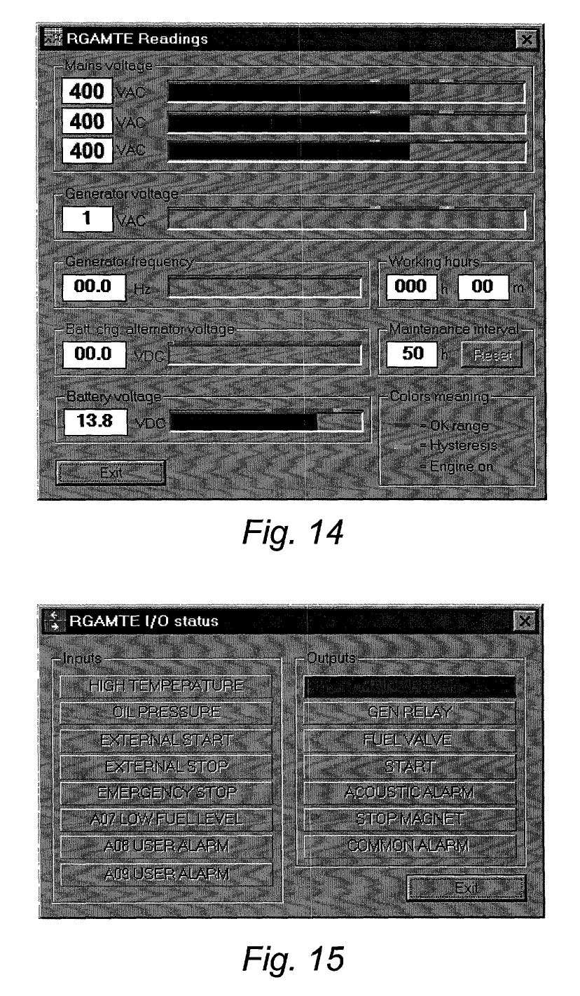

FIG. 14 is a video screen that may be displayed by computer system 20a which allows a user to visualize and read measurements such as mains voltage, generator voltage, generator frequency, generator voltage, battery charger alternator voltage, battery voltage, working hours and maintenance intervals. As discussed above the data illustrated by the video screen may be remotely received by the computer system 20a through modem 21.

FIG. 15 is a video screen that may be displayed by computer system 20a which allows a user to visualize generator input states (e.g., high temperature, oil pressure, external start, external stop, emergency stop, low fuel level, user alarm) and output states (e.g., mains relay, generator relay, fuel valve, start, acoustic alarm, stop magnet, common alarm) that are active. Detailed information regarding a particular input or output parameter state may be obtained upon selection thereof.

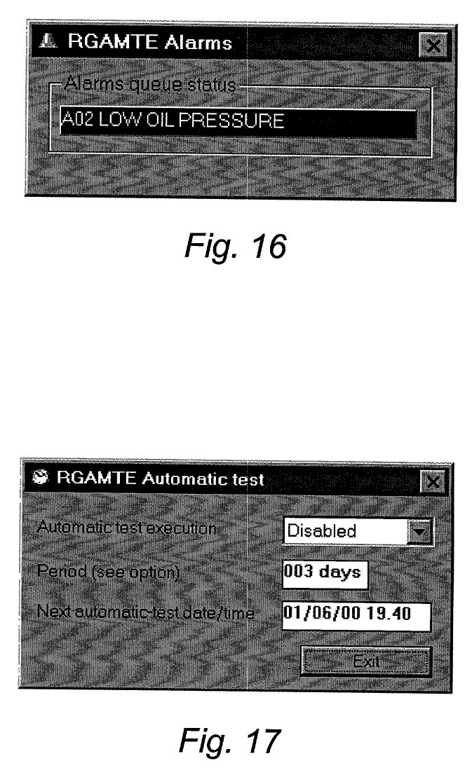

FIG. 16 is a video screen that may be displayed by computer system 20a which allows a user to view an alarm. For example, FIG. 16 illustrates a low oil pressure alarm which caused the generator to stop.

FIG. 17 is a video screen that may be displayed by computer system 20a which allows a user to set a day and time for a test to begin.

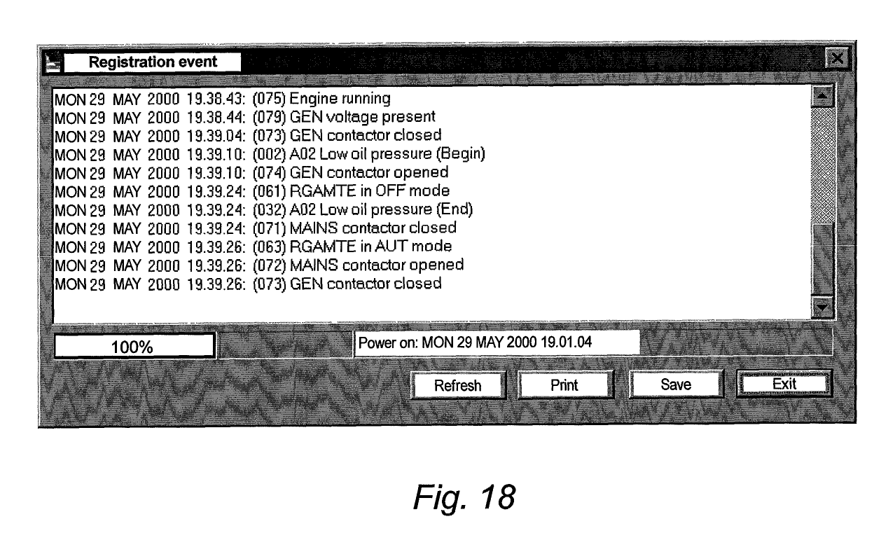

FIG. 18 is a video screen that may be displayed by computer system 20a which allows a user to review a log of the latest events (e.g., the last 255 events) relating to the power generator operation that have been recorded along with their corresponding date and time. Changes made by the user, including passage from manual to automatic operation, may be recorded.

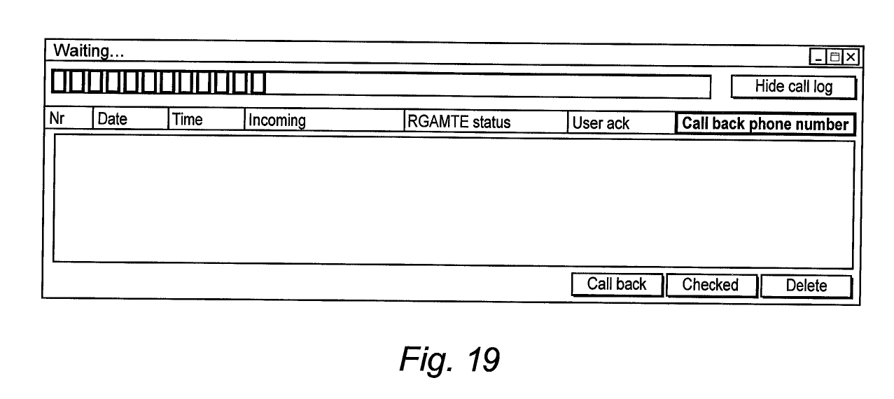

FIG. 19 is a video screen that may be displayed by computer system 20a which allows a user to view events reflecting communications between generator 10 and computer system 20a. For example, when the control by computer system 20a is activated, a user will see only the bar that indicates call waiting (see FIG. 19) on the computer screen. When any generating set (furnished with the processing system and/or controller) shows an anomaly or goes into programmed maintenance, a screen will appear which indicates (from left to right on the computer video screen of FIG. 19): “Nr”=indicates the progressive number of calls, “Date”=date of the call, “Time”=time of the call, “Incoming call from”=gives the name of the generator that sends the call, “RGAMTE status”=gives the reason for the call, “User ack”=indicates if the call has already been responded to or if it must be responded to, “Call back phone number”=Telephone number of the modem for the generator.

Controller 105 may communicate with the processing system 20 in two different ways: (1) using an analog modem (e.g., U.S. Robotics) or (2) using a GSM modem. Using an analog modem, transmission of the data may be communicated using a normal telephone line. Using a GSM modem 107b (e.g., FALCOM), normal SIM CARDS can be used (rechargeable cards too) and wireless data transmission/reception may be performed in the form of SMS messages. This GSM system may enable data transmission even with a weak signal. The advantages of the GSM modem may include: (i) In case of alarm, the generator calls two mobile numbers, (ii) The alarm and measurements of the generator may be displayed directly on the computer screen 20a or mobile phone's screen 20b, (iii) The generator can be controlled directly by the mobile phone without the use of a PC. It is enough to send an SMS message to the board. After having followed the command (start, stop, etc.) the generator sends a message to the mobile giving all of the measurements and the state of the board.

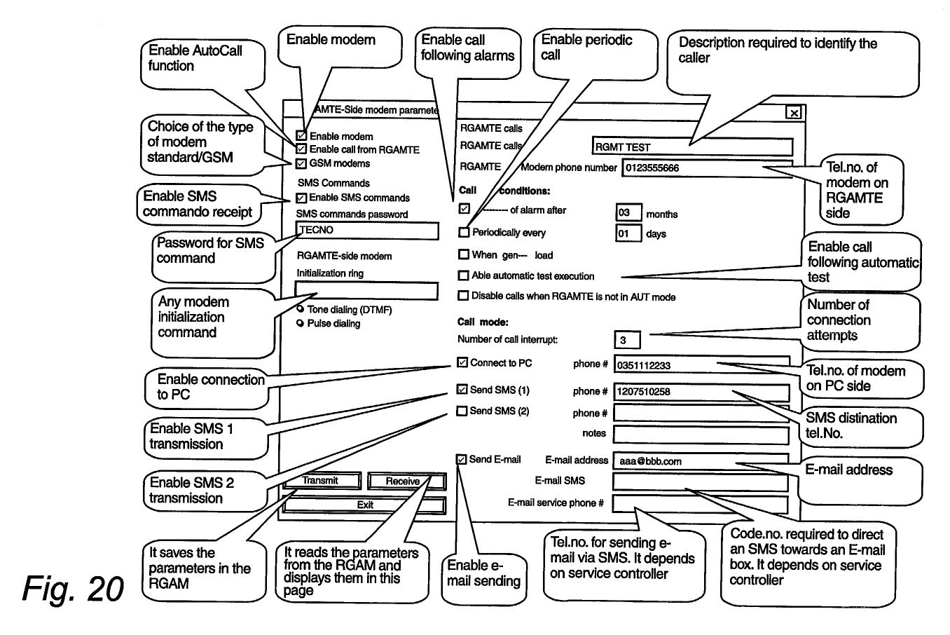

FIG. 20 is a video screen that may be displayed by computer system 20a which allows a user to review and change settings for a GSM modem including for example enabling calls under certain conditions.

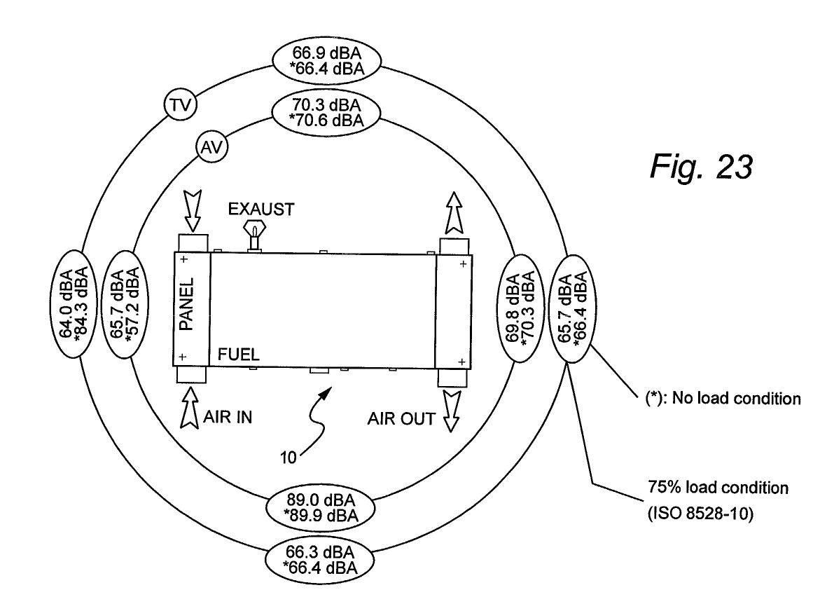

FIG. 23 illustrates noise level measurements of generator 10 at various load conditions. Since generator 10 is designed for continuous use and to power cellular base stations, an additional super quiet muffler may be mounted on the generator in order to further reduce its noise level. Due to its relatively low noise, generator 10 may be located near to residential areas without disturbing people.

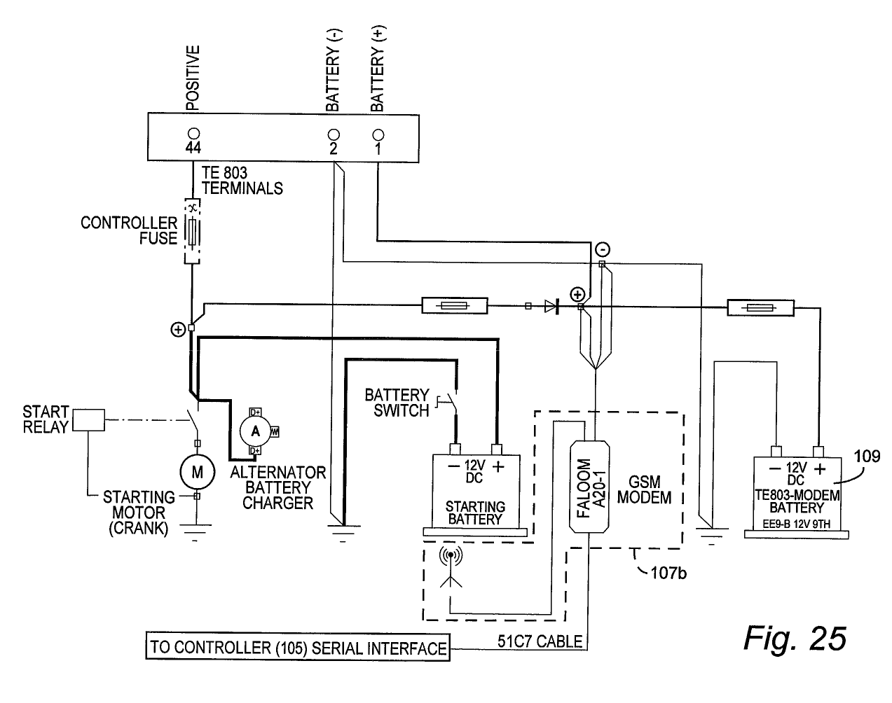

Referring to FIGS. 2 and 25, an auxiliary battery 109 may be included as part of generator 10 in order to guarantee the communication between modem 107 and processing system 20. As illustrated in FIG. 25, auxiliary battery feeds the modem 107 (e.g., GSM modem 107a) and controller 105 in case the battery of generator 10 is damaged or has a voltage drop (e.g., during a start in low temperature conditions).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. For example, while power generator 10 was described above as providing on-site electrical power to a cellular base station, the power generator may be used to provide on site power for other applications such as providing power for a computer terminal room, residential house or apartment, office, hospital, school, restaurant, etc. The power generator connected to these other applications may be remotely monitored and controlled as discussed above.

What is claimed is:

1. An electrical power generator for outputting onsite electrical power to a cellular base station, the power generator comprising:
an engine;
an alternator operatively coupled to the engine;
a controller, operatively coupled to the engine and alternator, for controlling at least one operational parameter relating to the engine or alternator, and
a modem, operatively coupled to the controller, for receiving data from a remote source, the received data being processed by the controller to control the operational parameter.

2. The power generator of claim 1 wherein the power generator includes a switch for disconnecting electrical power form the power generator to the cellular base station in favor of another source of power to the cellular base station.

3. The power generator of claim 1 wherein the modem for communicating data comprises a GSM modem for wirelessly transmitting and receiving the data.

4. The power generator of claim 1 wherein the engine is a diesel powered engine.

5. The power generator of claim 4 wherein the engine includes an oil sump which contains at least 11 liters of oil.

6. The power generator of claim 1 wherein controller is capable of running a load test for optimizing operation of the engine, data reflecting the load test being remotely transmitted by the modem.

7. The power generator of claim 1 further comprising a battery for providing power to start the engine and an auxiliary battery for providing auxiliary electrical power to the controller and the modem.

8. A system comprising:
a cellular base station for communicating signals with one or more cellular telephones;
an electical power generator located on the site of and connected to the cellular base station, the power generator including an engine, an alternator coupled to the engine, a controller for controlling at least one operational parameter of the alternator or engine, and a modem for remotely communicating data relating to the operational parameter of the alternator or engine; and
a processing system remotely located from the power generator and the cellular base station, the processing system communicating data with the modem.

9. The system of claim 8 wherein the modem is a GSM modem for wirelessly transmitting and receiving data from the processing system, the processing system comprising a a computer system including another modem.

10. The system of claim 8 wherein the modem is a GSM modem for wirelessly transmitting and receiving data from the processing system, the processing system comprising a cellular telephone.

11. The system of claim 8 wherein the engine is a diesel powered engine.

12. The system of claim 11 wherein the engine includes an oil sump which contains at least 11 liters of oil.

13. The system of claim 8 wherein the controller is capable of running a load test for optimizing operation of the engine, data reflecting the load test being transmitted from the modem to the processing system.

14. The system of claim 8 wherein the power generator further comprises a battery for providing power to start to the engine and an auxiliary battery for providing auxiliary electrical power to the controller and the modem.

15. The system of claim 9 further comprising another cellular base station and another on-site electical power generator located on the site of and connected to the another cellular base station, and another modem for remotely communicating data relating to the operational parameter of the another power generator to the processing system, the processing system being remotely located from the another base station and the another on-site electrical power generator.

16. A method of remotely controlling a power generator which provides on-site electrical power to a cellular base station, the method comprising:
receiving in a modem of the power generator data from a processing system that is remotely located from the power generator, the received data reflecting a command for controlling at least one operational parameter of an alternator or engine of the power generator; and
processing the received data and controlling the operational parameter of the alternator or engine of the power generator in accordance with the received data.

17. The method of claim 16 wherein the modem is a GSM modem for wirelessly receiving the data.

18. The method of claim 17 further comprising switchably connecting primary and auxiliary batteries to the GSM modem.

19. The method of claim 16 wherein the data received by the modem originates from a cellular telephone.

20. The method of claim 16 wherein the data received by the modem originates from a computer system having another modem.

21. The method of claim 16 further comprising running a load test for optimizing operation of the engine, data reflecting the load test being wirelessly transmitted from the power generator to the processing system.

22. A method of remotely controlling first and second on-site power generators using a same processing system, the method comprising:
receiving in a first modem of the first power generator data from the processing system, the processing system being remotely located from the first power generator, the data received by the first modem reflecting a command for controlling at least one operational parameter of an alternator or engine of the first power generator;
processing the data received by the first modem and controlling the operational parameter of the alternator or engine of the first power generator in accordance with the data received by the first modem;
receiving in a second modem of the second power generator data from the processing system, the processing system being remotely located from the second power generator, the data received by the second modem reflecting a command for controlling at least one operational parameter of an alternator or engine of the second power generator; and
processing the data received by the second modem and controlling the operational parameter of the alternator or engine of the second power generator in accordance with the data received by the second modem.

23. The method of claim 22 wherein the first and second power generators are operatively connected to first and second cellular base stations, respectively.

24. The method of claim 22 wherein at least one of the first and second modems is a GSM modem for wirelessly receiving data from the processing system.

25. The method of claim 24 wherein the processing system comprises a cellular telephone.

26. The method of claim 24 wherein the processing system comprises a computer system having a third modem.

27. The power generator of claim 1 further comprising a load bank which is switchably connected to the alternator.

28. The system of claim 8 wherein the power generator includes a load bank which is switchably connected to the alternator.

29. The method of claim 16 wherein the alternator is switchably connected to a load bank.

30. The method of claim 22 wherein at least one of the alternators in the first or second power generators is switchably connected to a load bank.
